(19) United States
(12) Patent Application Publication
(10) Pub. No.: US 2016/0354646 A1
(43) Pub. Date: Dec. 8, 2016

(54) ILLUMINATIVE BALL

(71) Applicant: Andrew WANG, Taipei City (TW)

(72) Inventor: Andrew WANG, Taipei City (TW)

(21) Appl. No.: 14/728,827

(22) Filed: Jun. 2, 2015

(51) Int. Cl. A63B 43/06; F21V 23/04; F21V 33/00

(52) U.S. Cl. CPC A63B 43/06; F21V 33/008; F21V 23/0442; F21Y 2101/02

(57) ABSTRACT

An illuminative ball contains: an opening defined on the illuminative ball; and a fixing mount connected with the illuminative ball and corresponding to the opening to fix an illuming unit. The fixing mount is made of flexible plastic or rubber, and the illuming unit has at least one cell, a LED light, and a sensing switch, wherein a fitting sleeve is fitted with an outer wall of the illuming unit and is made of flexible plastic or rubber to fix the at least one cell tightly, and a flexible cap is fitted into the opening of the illuminative ball and positions the illuming unit. The fixing mount has a retaining groove defined adjacent to a top end of the fixing mount, and the flexible cap has a locking rib extending outwardly from a bottom end thereof to retain with the retaining groove of the fixing mount.

### FIELD OF THE INVENTION

The present invention relates to an illuminative ball in which an illuming unit is fixed securely to emit lights, when the illuminative ball bounces.

### BACKGROUND OF THE INVENTION

A conventional ball, such as basketball, volleyball, soccer, and rugby, cannot emit lights at night. To overcome this problem, a light bulb is accommodated in the ball, wherein the ball contains an illuming assembly covered therein. In other words, the illuming assembly cannot be removed from the ball, so a cell of the illuming assembly cannot be replaced. Furthermore, the illuming assembly is broken easily, when the ball bounces.

The present invention has arisen to mitigate and/or obviate the afore-described disadvantages.

### SUMMARY OF THE INVENTION

The primary objective of the present invention is to provide an illuminative ball which contains an opening and a fixing mount made of flexible plastic or rubber to accommodate an illuming unit, wherein the illuming unit is comprised of at least one cell, a LED light, and a sensing switch, and wherein a fitting sleeve is fitted with an outer wall of the illuming unit, a flexible cap is fitted into the opening of the illuminative ball, such that the illuming unit is fixed securely by ways of the fixing mount, the fitting sleeve, and the flexible cap.

Another objective of the present invention is to provide an illuminative ball in which the at least one cell is replaced easily and the illuminating unit is protected completely, when the illuminative ball bounces.

### BRIEF DESCRIPTION OF THE DRAWINGS

FIG. 1 is a perspective view showing the exploded components of an illuminative ball according to a preferred embodiment of the present invention.

FIG. 2 is a cross sectional view showing the exploded components of the illuminative ball according to the preferred embodiment of the present invention.

FIG. 3 is a cross sectional view showing the operation of the illuminative ball according to the preferred embodiment of the present invention.

### DETAILED DESCRIPTION OF THE PREFERRED EMBODIMENTS

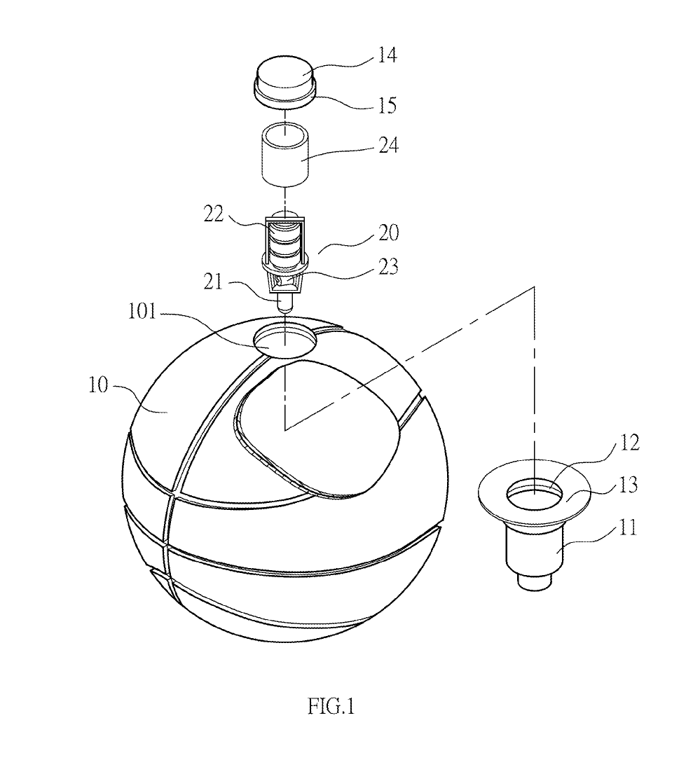

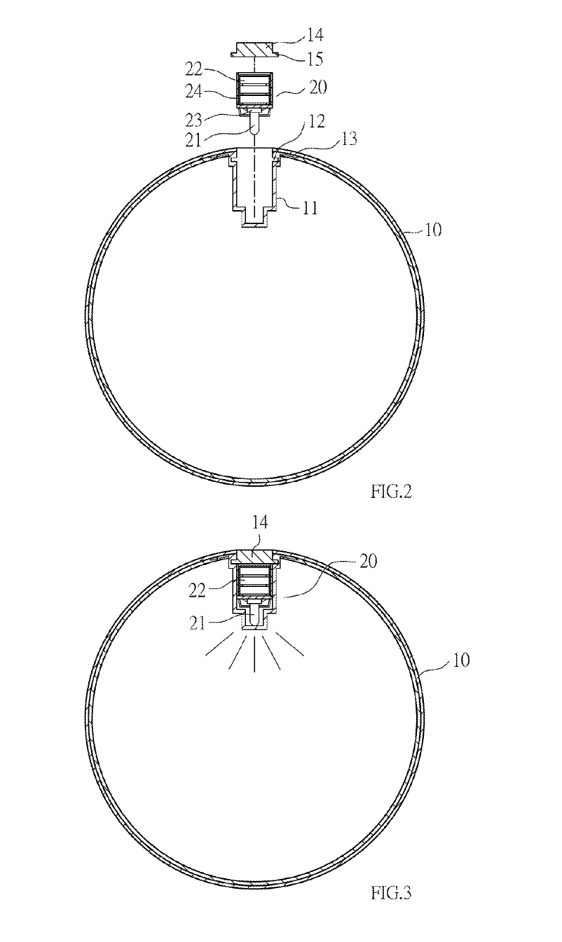

With reference to FIGS. 1-3, an illuminative ball 10 according to a preferred embodiment of the present invention comprises: an opening 101 defined on the illuminative ball 10; and a fixing mount 11 connected with an inner wall of the illuminative ball 10 and corresponding to the opening 101, wherein the fixing mount 11 is made of flexible plastic or rubber and has a retaining groove 12 defined adjacent to a top end of the fixing mount 11, a connecting tab 13 extending outwardly from the top end of the fixing mount 11 to connect the fixing mount 11 with the illuminative ball 10, and an illuming unit 20 mounted in the fixing mount 11, wherein the illuming unit 20 is comprised of at least one cell 22, a LED light 21, and a sensing switch 23, and wherein a fitting sleeve 24 is fitted with an outer wall of the illuming unit 20 and is made of flexible plastic or rubber. In addition, a flexible cap 14 is fitted into the opening 101 of the illuminative ball 10 and has a locking rib 15 extending outwardly from a bottom end thereof to retain with the retaining groove 12 of the fixing mount 11.

Thereby, the illuminative ball 10 of the present invention has advantages as follows:

1. The illuming unit 20 has the sensing switch 23 so that when the illuminative ball 10 bounces, the sensing switch 23 senses a vibration of the illuminative ball 10 to electrically conduct with the at least one cell 22, and then the sensing switch 23 starts the LED light 21 to emit lights. After the illuminative ball 20 stops bounce, the sensing switch 23 turns off.

2. The fitting sleeve 24 is made of the flexible plastic or rubber, so it is fitted with the illuming unit 20 tightly to fix the at least one cell 22 tightly.

3. The fixing mount 11 is made of the flexible plastic or rubber to affix the illuming unit 20 securely and to protect the illuming unit 20 as the illuminative ball 10 bounces.

4. The flexible cap 14 facilitates a positioning of the illuming unit 20.

5. The illuminative ball 10 has shockproof and waterproof function by ways of the fixing mount 11, the fitting sleeve 24, and the flexible cap 14.

6. As desiring to replace the at least one cell 22, the flexible cap 14 is removed from the illuminative ball 10 easily to replace the at least one cell 22 in the illuming unit 20 quickly.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. An illuminative ball comprising:
an opening defined on the illuminative ball;
an illuming unit, comprising:
at least one cell;
a LED light;
a sensing switch; and
a fitting sleeve fitted with an outer wall of the illuming unit, the fitting sleeve being made of flexible plastic or rubber to fix the at least one cell tightly;
a fixing mount connected with an inner wall of the illuminative ball and corresponding to the opening, the fixing mount accommodating and fixing the illuming unit, the fixing mount being made of flexible plastic or rubber to fix the illuming unit; and
a flexible cap fitted into the opening of the illuminative ball and that positions the illuming unit,
wherein the fixing mount comprises:
a connecting tab extending outwardly from the top end thereof to connect the fixing mount with the illuminative ball; and
a retaining groove defined disposed below the connecting tab, and
wherein the flexible cap has a locking rib extending outwardly from a bottom end thereof to retain with the retaining groove of the fixing mount.

2. (canceled)

3. (canceled)
